(19) United States
(12) Patent Application Publication
(10) Pub. No.: US 2024/0257242 A1
(43) Pub. Date: Aug. 1, 2024

(54) METHODS AND SYSTEM FOR DERIVATIVE TRADING ON AUTOMATED MARKET MAKER LIQUIDITY POOLS

(71) Applicants: Wellfield Technology IR Limited, Dublin (IE); THE IP LAW FIRM OF GUYLEVI, LLC, Wyckoff, NY (US)

(72) Inventor: Levy Cohen, Herzelia (IL)

(21) Appl. No.: 18/562,542

(22) PCT Filed: May 18, 2022
(86) PCT No.: PCT/US22/29814

§ 371 Date: Nov. 20, 2023

Related U.S. Application Data
(60) Provisional application No. 63/190,009, filed on May 18, 2021.

(51) Int. Cl. G06Q 40/04

(52) U.S. Cl. CPC G06Q 40/04

(57) ABSTRACT

The disclosure relates to systems, methods and computer-readable media for hedging and derivative trading in automated market maker (AMM) protocols. Specifically, the disclosure relates to systems, methods and computer-readable media for trading in future contracts of a simultaneously minted crypto assets backed tokens, issued against each crypto asset in the trading pair.

### BACKGROUND

The disclosure is directed to systems, methods and computer-readable media for hedging and derivative trading in automated market maker (AMM) protocols. Specifically, the disclosure is directed to systems, methods and computer-readable media for trading in future contracts of a simultaneously minted crypto assets backed tokens, issued against each crypto asset in the trading pair.

With increased exchange in cryptocurrencies between individuals using electronic wallets, as well as large public exchanges, broad fluctuations in market pricing of such blockchain-based coins and tokens occurred, providing opportunities for arbitrage, as well as derivatives trading.

Due to the inherent limitations of blockchain technology, it has been a challenge to build decentralized exchanges (DEXes), which meaningfully compete with their centralized counterparts. In addition, DEXes are typically not configured to operate derivative trading in an automated manner.

These and other shortcomings of the current state of affairs are addressed by the following disclosure, FIGURES and claims.

### SUMMARY

Disclosed, in various embodiments, are systems, methods and computer-readable media for providing cryptocurrency liquidity for trading in future contracts of a simultaneously minted crypto assets backed tokens, issued against each crypto asset in the trading pair.

In an embodiment provided herein is a computerized method of trading a futures contract, implementable at a blockchain of a peer-to-peer distributed network designed to trade futures on a pair of crypto assets' (CA) options, the method comprising: a liquidity provider (LP), depositing in an automated market maker (AMM) liquidity pool on the blockchain of a peer-to-peer distributed network a pair of a first crypto asset (CA1) and a second crypto asset (CA2) at a predetermined ratio of CA1:CA2; receiving from the automated market maker liquidity pool a receipt for the total sum of CA1 and CA2 at the predetermined ratio of CA1:CA2; the LP submitting the receipt to a decentralized application (DeAPP) associated with the blockchain of a peer-to-peer distributed network; the LP, receiving from the DeApp a first token (IOU1) for redeeming CA1, and a second token (IOU2) for redeeming CA2; and the LP, using at least one of: IOU1, and IOU2, establishing an automated market maker for trading at least one of the trading pairs of: IOU1:CA1 or CA2, thereby establishing AMM1 IOU2:CA2, or CA1, thereby establishing AMM2, and IOU1 or IOU2: any crypto asset (CAn) thereby establishing AMM3.

These and other features of the systems, methods and computer-readable media for trading in future contracts of a simultaneously minted crypto assets backed tokens, issued against each crypto asset in the trading pair, will become apparent from the following detailed description when read in conjunction with the figures and examples, which are exemplary, not limiting.

### BRIEF DESCRIPTION OF THE FIGURES

NA.

### DETAILED DESCRIPTION

Provided herein are embodiments of systems, methods and computer-readable media for trading in future contracts of a simultaneously minted crypto assets backed tokens, issued against each crypto asset in the trading pair.

Accordingly and in an exemplary implementation, provided herein is a computerized method of trading a futures contract, implementable at a blockchain of a peer-to-peer distributed network designed to trade futures on a pair of cryptocurrency assets' (CA) options, the method comprising: a liquidity provider (LP, referring to any entity that facilitates the purchase and sale by investors on a secondary market such as an exchange), depositing in an automated market maker (AMM) liquidity pool on the blockchain of a peer-to-peer distributed network a pair of a first crypto asset (CA1) and a second crypto asset (CA2) at a predetermined ratio of CA1:CA2; receiving from the automated market maker liquidity pool a receipt for the total sum of CA1 and CA2 at the predetermined ratio of CA1:CA2; the LP submitting the receipt to a decentralized application (DeAPP) associated with the blockchain of a peer-to-peer distributed network; the LP, receiving from the DeApp a first token (IOU1) for redeeming CA1, and a second token (IOU2) for redeeming CA2; and the LP, using at least one of: IOU1, and IOU2, establishing an automated market maker for trading at least one of the trading pairs of: IOU1:CA1 or CA2, thereby establishing AMM1 IOU2:CA2, or CA1, thereby establishing AMM2, and IOU1 or IOU2: any crypto asset (CAn) thereby establishing AMM3.

In the context of the disclosure, the term “automated market makers” refer to smart contracts that hold liquidity reserves (or liquidity pools) that traders can trade against. These liquidity pools are funded by liquidity providers (LPs). Anyone depositing an equivalent value of two crypto assets in the pool, can be come a liquidity provider (LP). In return, traders pay a fee to the pool that is then distributed to LPs according to their share of the pool. Likewise, the term “crypto-asset” (CA), refers to any type or family of digital cryptographic-based asset, such as decentralized, tradeable tokens and coins, based on mathematical hashing, and secure transactions between two individuals or servers whereby the crypto-assets may be bought, sold, traded or used to purchase other assets. These tokens and coins can represent many different projects with different use-cases, from digital currencies, to computing infrastructure, to identity verification, to non-fungible tokens (NFTs).

In an exemplary implementation, LPs get “liquidity tokens,” or receipts for their deposit, representing their share of the entire liquidity pool. These liquidity tokens (interchangeable with receipt) can be later redeemed for the share they represent in the pool.

For example, LP deposits in, for example a constant product market maker (CPMM), two Cas, A′ and B′ where the price of ′A is 1000 times the price of ′B. LP deposits a 1MM units of ′A and 1000 units of ′B such that the LP receives million receipts for ′A (R_{A}) and 1000 receipts for ′B (R_{B}). Since at the moment, assuming the trading of R_{A} and R_{B} is solely through existing AMMs, there is no mechanism for trading in R_{A}, or R_{B}. Consequently, the LP will establish AMM1 for trading pair of R_{A}:′A (million R_{A} against million ′A), and/or AMM2 for trading pair R_{B}:′B (1000 R_{B} against 1000 ′B), as well as potentially, AMM3, against other crypto assets (CAn). Under these circumstances, the LP must invest 3MM in all 3 AMMs, while current liquid pool value is only 2MM.

In other words, the LP managed to establish AMMs at 1.5 times the value of the initial investment and each AMM can then recursively issue new receipts using the disclosed methods, for example, for the trading pair of R_{A}:′A (2^{nd} order derivative e.g.,), which can be further traded and used to establish additional AMMs. The more AMMs any LP establishes, the amount of money reserved will approach 2× the initial investment, depending on the amount of interest in the trading pairs. In in subsequent AMM, the LP provides liquidity only to one side in the trading pair, as well as establishing AMM only with R_{A}: R_{B}.

For Example, assuming a trader purchases 1000 R_{A} for 1000′A. Then, sometimes thereafter, the price of ′B increase to X times pB relative to pA. The impact on the ′A:′B AMM is that now the number of ′B (u′B) will be reduced by X^{1/2}, and the umber of ′A (u′A) will increase by X^{1/2}. Now the trader has 1000 receipts (tokens) worth X^{1/2}·u′A. Therefore, this is a way to increase u′A in the trader's possession. Additionally, or alternatively, if the trader wants to hedge against increase in p′B, a similar effect will result. Accordingly, if the trader had u′A=1000, then, in relation to ′B (after the increase in p′B, each p′A would have been worth 1/X of its initial value (p). On the other hand, since each R_{A} is now worth X^{1/2} ′A, then, as far as the trader is concerned, the value of R_{A} in relation to p′B decreased only X^{1/2}·′pB, and not by X·p′B.

If on the other hand, the value of p′A will increase (in relation to p′B) by X·p′A, then, u′A in relation to u′B will be 1,000,000/X^{1/2}, and therefore each R_{A}, will be worth only 1/X^{1/2} u′A. Accordingly, since the trader used u′A for the purchase, the trader will have lost X^{1/2} relative to the alternative of reserving the u′A. In other words, in a decrease of p′A by X, the trader loses X^{1/2}·p′A, but an increase in “A by the same X, the trader will gain only X^{1/2}·p′A. Thus the trader chose a strategy where the losses are minimized, but so are the gains.

Additionally or alternatively, a trader wishing to hedge against increase in p′B further, the trader can purchase from AMM1, the receipt (split token) of R_{A} (R_{RA}, or R²_{A}) and then for every increase of B by X times pB relative to pA, the value of R_{A} in relation to p′B decreased only X^{1/2}·′pB, and the value of R²_{A} will now only decrease by X^{1/4}·′pB and in a recursive manner, a series of hedges can be established.

The computer program (software and/or firmware), can comprise program code means for carrying out the steps of the methods described herein, as well as a computer program product comprising program code means stored on a medium that can be read by a computer, such as a floppy disk, a hard disk, CD-ROM, DVD, USB memory stick, or a storage medium that can be accessed via a data network, such as the Internet or Intranet, when the computer program product is loaded in the main memory of a computer and is carried out by the computer.

Memory device(s) as used in the methods described herein can be any of various types of non-volatile memory computer-readable media or storage computer-readable media (in other words, memory computer-readable media that do not lose the information thereon in the absence of power). The term “memory device” is intended to encompass an installation medium, e.g., a CD-ROM, floppy disks, or tape device or a non-volatile memory such as a magnetic media, e.g., a hard drive, optical storage, or ROM, EPROM, FLASH, etc. The memory device may comprise other types of memory as well, or combinations thereof. In addition, the memory medium may be located in a first computer in which the programs are executed, and/or may be located in a second different computer which connects to the first computer over a network, such as the Internet. In the latter instance, the second computer may further provide program instructions to the first computer for execution. The term “memory device” can also include two or more memory computer-readable media which may reside in different locations, e.g., in different computers that are connected over a network.

Further, CPM may be operably coupled to the various modules and components with appropriate circuitry. may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, an engine, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

Unless specifically stated otherwise, as apparent from the following discussions, it is appreciated that throughout the specification discussions utilizing terms such as “processing.” “loading.” “in communication,” “detecting.” “calculating.” “determining”, “analyzing.” or the like, refer to the action and/or processes of a computer or computing system, or similar electronic computing device, that manipulate and/or transform data represented as physical, such as a transistor architecture into other data similarly represented as physical and structural layers.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them. Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Exemplary implementations of the subject matter described and claimed herein can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives.

All ranges disclosed herein are inclusive of the endpoints, and the endpoints are independently combinable with each other. “Combination” is inclusive of blends, mixtures, alloys, reaction products, and the like. The terms “a”, “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the stream(s) includes one or more stream). Reference throughout the specification to “one embodiment”, “another embodiment”, “an embodiment”, and so forth, when present, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

Accordingly, provided herein is a computerized method of trading a futures contract, implementable at a blockchain of a peer-to-peer distributed network designed to trade futures on a pair of crypto assets' (CA) options, the method comprising: a liquidity provider (LP), depositing in an automated market maker (AMM) liquidity pool on the blockchain of a peer-to-peer distributed network a pair of a first crypto asset (CA1) and a second crypto asset (CA2) at a predetermined ratio of CA1:CA2; receiving from the automated market maker liquidity pool a receipt for the total sum of CA1 and CA2 at the predetermined ratio of CA1:CA2; the LP submitting the receipt to a decentralized application (DeAPP) associated with the blockchain of a peer-to-peer distributed network; the LP, receiving from the DeApp a first token (IOU1) for redeeming CA1, and a second token (IOU2) for redeeming CA2; and the LP, using at least one of: IOU1, and IOU2, establishing an automated market maker for trading at least one of the trading pairs of: IOU1:CA1 or CA2, thereby establishing AMM1 IOU2:CA2, or CA1, thereby establishing AMM2, and IOU1 or IOU2: any crypto asset (CAn) thereby establishing AMM3, wherein (i) the first blockchain of the peer-to-peer distributed network is the Ethereum network, CA1 is Ether (ETH) and CA2 is a bitcoin (BTC), (ii) the step of receiving from the DeApp a first token (IOU1) for redeeming CA1, and a second token (IOU2) for redeeming CA2 comprises the DeAPP simultaneously minting a pair of ETH20 tokens for each of CA1 and CA2 separately at their current value as determined by the AMM liquidity pool, wherein (iii) the value of IOU1 is equal to the value of IOU2, wherein (iv) the swap ratio between IOU1 and CA1 (IOU1:CA1), or IOU1 and CA2 (IOU1:CA2), is determined by AMM1, wherein (v) the swap ratio between IOU2 and CA2 (IOU2:CA2), or IOU2 and CA1 (IOU2:CA1), is determined by AMM2, wherein (vi) the automated market maker (AMM) liquidity pool is a constant product market maker (CPMM), wherein (vii) the step of receiving from the automated market maker liquidity pool a receipt for the total sum of CA1 and CA2 at the predetermined ratio of CA1:CA2; comprising the CPMM minting a liquidity token, (viii) the step of receiving from the DeApp IOU1 for redeeming CA1, and IOU2 for redeeming CA2 comprises using the liquidity token, minting IOU1 and IOU2, wherein (ix) CA1, or CA2 is DAI, USDT, USDC, ETH, or BTC, so long as CA1 is different than CA2, wherein (x) the method further comprising the step of: Following the step of establishing AMM1, receiving from AMM1 a receipt for the total sum of IOU1, and CA1 or CA2; the LP submitting the receipt to the decentralized application (DeAPP) associated with the blockchain of a peer-to-peer distributed network; the LP, receiving from the DeApp a first token (IOU²1) for redeeming IOU1, and a second token (IOU²CA2) for redeeming CA2 or IOU²CA1 for redeeming CA1; and the LP, using at least one of: IOU²1, and IOU²CA1, or IOU²CA2, establishing an automated market maker for trading at least one of the trading pairs of: IOU²1: IOU²CA1, and IOU²1: IOU²CA2, and wherein (xi) the method further comprising the step of: Following the step of establishing AMM2, receiving from AMM2 a receipt for the total sum of IOU2, and CA1 or CA2; the LP submitting the receipt to the decentralized application (DeAPP) associated with the blockchain of the peer-to-peer distributed network; the LP, receiving from the DeApp a first token (IOU²2) for redeeming IOU2, and a second token (IOU²CA1) for redeeming CA1 or IOU²CA2 for redeeming CA2; and the LP, using at least one of: IOU²2, and IOU²CA1, or IOU²CA2, establishing an automated market maker for trading at least one of the trading pairs of: IOU²2: IOU²CA1, and IOU²2: IOU²CA2.

Although the foregoing disclosure has been described in terms of some embodiments, other embodiments will be apparent to those of ordinary skill in the art from the disclosure herein. Moreover, the described embodiments have been presented by way of example only, and are not intended to limit the scope of the inventions. Indeed, the novel methods, programs, computer-readable media and systems described herein may be embodied in a variety of other forms without departing from the spirit thereof. Accordingly, other combinations, omissions, substitutions and modifications will be apparent to the skilled artisan in view of the disclosure herein.

What is claimed:

1. A computerized method of trading a futures contract, implementable at a blockchain of a peer-to-peer distributed network designed to trade futures on a pair of cryptocurrency assets' (CA) options, the method comprising:
a) a liquidity provider (LP), depositing by at least one computer of an electronic exchange coupled to a computer communications network, in an automated market maker (AMM) liquidity pool on the blockchain of a peer-to-peer distributed network a pair of a first crypto asset (CA1) and a second crypto asset (CA2) at a predetermined ratio of CA1:CA2;
b) receiving from the automated market maker liquidity pool a receipt for the total sum of CA1 and CA2 at the predetermined ratio of CA1:CA2;
c) the LP submitting the receipt to a decentralized application (DeAPP) associated with the blockchain of a peer-to-peer distributed network;
d) the LP, receiving from the DeApp a first token (IOU1) for redeeming CA1, and a second token (IOU2) for redeeming CA2; and
e) the LP, using at least one of: IOU1, and IOU2, establishing an automated market maker for trading at least one of the trading pairs of:
a. IOU1:CA1 or CA2, thereby establishing AMM1
b. IOU2:CA2, or CA1, thereby establishing AMM2, and
c. IOU1 or IOU2: any crypto asset (CAn) thereby establishing AMM3.

2. The method of claim 1, wherein the first blockchain of the peer-to-peer distributed network is the Ethereum network, CA1 is Ether (ETH) and CA2 is a bitcoin (BTC).

3. The method of claim 2, wherein the step of receiving from the DeApp a first token (IOU1) for redeeming CA1, and a second token (IOU2) for redeeming CA2 comprises the DeAPP simultaneously minting a pair of ETH20 tokens for each of CA1 and CA2 separately at their current value as deterimed by the AMM liquidity pool.

4. The method of claim 3, wherein the value of IOU1 is equal to the value of IOU2.

5. The method of claim 1, wherein the swap ratio between IOU1 and CA1 (IOU1:CA1), or IOU1 and CA2 (IOU1:CA2), is determined by AMM1.

6. The method of claim 1, wherein the swap ratio between IOU2 and CA2 (IOU2:CA2), or IOU2 and CA1 (IOU2:CA1), is determined by AMM2.

7. The method of claim 1, wherein the automated market maker (AMM) liquidity pool is a constant product market maker (CPMM).

8. The method of claim 7, wherein the step of receiving from the automated market maker liquidity pool a receipt for the total sum of CA1 and CA2 at the predetermined ratio of CA1:CA2; comprising the CPMM minting a liquidity token.

9. The method of claim 8, wherein the step of receiving from the DeApp IOU1 for redeeming CA1, and IOU2 for redeeming CA2 comprises using the liquidity token, minting IOU1 and IOU2.

10. The method of claim 1, wherein CA1, or CA2 is DAI, USDT, USDC, ETH, or BTC, so long as CA1 is different than CA2.

11. The method of claim 1, further comprising the step of:
a) Following the step of establishing AMM1, receiving from AMM1 a receipt for the total sum of IOU1, and CA1 or CA2;
b) the LP submitting the receipt to the decentralized application (DeAPP) associated with the blockchain of a peer-to-peer distributed network;
c) the LP, receiving from the DeApp a first token (IOU²1) for redeeming IOU1, and a second token (IOU²CA2) for redeeming CA2 or IOU²CA1 for redeeming CA1; and
d) the LP, using at least one of: IOU²1, and IOU²CA1, or IOU²CA2, establishing an automated market maker for trading at least one of the trading pairs of:
i. IOU²1: IOU²CA1, and
ii. IOU²1: IOU²CA2.

12. The method of claim 1, further comprising the step of:
a) Following the step of establishing AMM2, receiving from AMM2 a receipt for the total sum of IOU2, and CA1 or CA2;
b) the LP submitting the receipt to the decentralized application (DeAPP) associated with the blockchain of the peer-to-peer distributed network;
c) the LP, receiving from the DeApp a first token (IOU²2) for redeeming IOU2, and a second token (IOU²CA1) for redeeming CA1 or IOU²CA2 for redeeming CA2; and
d) the LP, using at least one of: IOU²2, and IOU²CA1, or IOU²CA2, establishing an automated market maker for trading at least one of the trading pairs of:
i. IOU²2: IOU²CA1, and
ii. IOU²2: IOU²CA2.
